(19) United States
(12) Patent Application Publication
(10) Pub. No.: US 2025/0334972 A1
(43) Pub. Date: Oct. 30, 2025

(54) TRANSPORT ROBOT, TRANSPORT MEANS, AND CONTROL METHOD THEREFOR

(71) Applicant: LG ELECTRONICS INC., Seoul (KR)

(72) Inventors: Bawoo CHA, Seoul (KR); Jaehong SEO, Seoul (KR); Seongmin SHIN, Seoul (KR); Moonchan KIM, Seoul (KR); Woojin KIM, Seoul (KR)

(73) Assignee: LG ELECTRONICS INC., Seoul (KR)

(21) Appl. No.: 18/870,118

(22) PCT Filed: Jun. 16, 2022
(86) PCT No.: PCT/KR2022/008561

§ 371 Date: Nov. 27, 2024

(51) Int. Cl. G05D 1/622; G05D 1/672; G05D 111/50

(52) U.S. Cl. CPC G05D 1/622; G05D 1/672; G05D 2111/58

(57) ABSTRACT

A transport robot can be controlled so that a connected trailer drives without colliding with an obstacle, the transport robot comprising: a body comprising a driving unit; and a connector holder which is positioned on the body and has a connector of a trailer coupled thereto, wherein the connector holder comprises: a fixed bracket fixed to the body, a rotation bracket rotatably coupled to the fixed bracket; a coupling pin which penetrates the connector of the trailer and is coupled to the rotation bracket, and an encoder for detecting rotation of the rotation bracket.

### TECHNICAL FIELD

Embodiments of the present disclosure relate to a transport robot for transporting one or more articles to a destination, a transport means, and a method for operating the same.

### BACKGROUND ART

To take charge of a portion of factory automation, robots have been developed for industrial use. Recently, the application range of robots has been further expanded, and robots that can be used in daily life as well as medical robots and aerospace robots are being developed.

Among industrial robots, robots that perform precise assembly work repeatedly perform the same operations and repeat the operations without encountering unexpected situations at a predetermined position, so that automation using the robots has been proceeded.

However, a transportation area including a traveling area (i.e., a driving area) where occurrence or non-occurrence of unexpected situations can be determined, has not yet been actively commercialized with robots. However, recently, as performance of sensors that recognize the surroundings has improved and computer technology that can quickly process the recognized information has evolved, the number of driving robots has rapidly increased.

Industrially, robots that are in charge of transportation functions have attracted attention and competition in robot technology is intensifying day by day. In addition to robots that transport bulky or large articles, there is a growing need for robots that perform services to transport small articles to destinations.

However, conventional goods transportation has difficulty in unloading loaded articles from a loading space to a destination. Since costs are increased when using an arm-shaped device like a person's arm, research on cheaper and more stable unloading methods capable of unloading articles is being actively conducted.

### DISCLOSURE

### Technical Problem

Embodiments of the present disclosure relate to a transport robot that moves while pulling a cart, and more particularly to a transport robot that calculates a driving path by detecting the position of the cart and thus travels along the calculated driving path, a transport means, and a method for controlling the same.

### Technical Solutions

In accordance with an aspect of the present disclosure, a transport robot may include: a body configured to include a driving unit; and a connector holder located in the body and coupled to a connector of a trailer, wherein the connector holder includes: a fixed bracket fixed to the body; a rotation bracket rotatably coupled to the fixed bracket; a fastening pin configured to penetrate the connector of the trailer and fastened to the rotation bracket; and an encoder configured to detect rotation of the rotation bracket.

The transport robot may include: at least one stopper located on one side of the rotation bracket and configured to limit a rotation range of the rotation bracket.

The stopper may be located in a driving direction of the driving unit of the rotation bracket, wherein the stopper is provided to be bilaterally symmetrical with respect to the driving direction.

The transport robot may include a controller configured to calculate position information of the trailer based on rotation amount data of the rotation bracket measured by the encoder.

The controller may calculate position information of the trailer based on the rotation amount data of the rotation bracket and information about a length and width of the trailer, wherein the position information of the trailer includes position information of four corners of a bottom surface of the trailer.

The transport robot may further include: a sensor unit configured to detect at least one surrounding obstacle, wherein the controller is configured to calculate position information of the obstacle based on information about a peripheral area recognized by the sensor unit.

The controller may calculate a driving path to a destination based on fixed map information about the destination; and may calculate a modified path and a driving speed for enabling the transport robot to move while avoiding the obstacle based on the position information of the trailer and the position information of the obstacle.

The controller may calculate an expected position of the trailer based on wheel position information of the trailer, weight information of the trailer, and weight information of articles loaded on the trailer; and may calculate the modified path and the driving speed to prevent the transport robot from colliding with the obstacle at the expected position of the trailer.

The controller may measure a distance to the trailer based on position information of the obstacle and position information of the trailer; and may set the driving speed to zero “0” when the trailer is located within a predetermined distance from the obstacle.

The controller may rotate the body such that a direction of the encoder is at an angle of 180 degrees with respect to the driving direction; and may calculate a modified path so that the transport robot drives in a straight direction until the obstacle and the trailer are spaced apart from each other by a predetermined distance or more.

In accordance with another aspect of the present disclosure, a transport means may include: a transport robot including a body provided with a driving unit and a connector holder coupled to the body; and a trailer including a connector rotatably coupled to the connector holder of the transport robot, wherein the connector holder includes: a fixed bracket fixed to the body; a rotation bracket rotatably coupled to the fixed bracket; and a fastening pin configured to penetrate the connector of the trailer and fastened to the rotation bracket.

The connector may include: a connection bracket rotatably coupled to a frame of the trailer in a vertical direction; and a rod-end bearing located at an end of the connection bracket and configured to enable the fastening pin to pass therethrough.

The transport means may further include: an auxiliary roller rotatably coupled to a lower part of the connection bracket with respect to a rotary shaft arranged horizontal to an extension direction of the connection bracket.

The transport robot may further include: an encoder configured to detect rotation of the rotation bracket; and a controller configured to calculate position information of the trailer based on rotation amount data of the rotation bracket measured by the encoder.

The transport robot may further include: a sensor unit configured to detect at least one surrounding obstacle. The controller may calculate position information of an obstacle based on information about a peripheral area recognized by the sensor unit; may calculate a driving path to a destination based on fixed map information about the destination; and may calculate a modified path and a driving speed for enabling the transport robot to move while avoiding the obstacle based on the position information of the trailer and the position information of the obstacle.

In accordance with another aspect of the present disclosure, a method for controlling a transport robot may include: receiving a command required to move the transport robot to a destination; calculating a driving path to the destination; calculating a driving speed; controlling a driving unit so that the transport robot drives along the driving path at the driving speed; calculating position information of a connected trailer; recognizing obstacles present in a peripheral area; and calculating a modified path so that the trailer does not collide with the obstacle based on the position information of the trailer.

The method may further include measuring a distance to the trailer based on position information of the obstacle and position information of the trailer; and setting the driving speed to zero “0” when the trailer is located within a predetermined distance from the obstacle.

The method may further include: rotating the transport robot such that a direction of connection between the trailer and the transport robot is at an angle of 180 degrees with respect to a driving direction; and calculate a modified path so that the transport robot drives in a straight direction until the obstacle and the trailer are spaced apart from each other by a predetermined distance or more.

The calculating the position information of the trailer may include: receiving information about an angle between the trailer and the transport robot; and calculating an expected position of the trailer based on the angle, wheel position information of the trailer, weight information of the trailer, and weight information of articles loaded on the trailer.

The method may further include: calculating the modified path and the driving speed to prevent the transport robot from colliding with the obstacle at the expected position of the trailer . . .

### Advantageous Effects

As is apparent from the above description, the transport robot according to the present disclosure can monitor the angle relative to a connected trailer in real time, so that the transport robot can secure the position information of the connected trailer in real time.

In addition, based on the position information of the trailer, the transport robot can determine the distance from the trailer without a sensor attached thereto to the obstacle, so that the transport robot can control the connected trailer to drive without collision with the obstacle.

Even if there is a risk of collision, the transport robot can design an escape path in a direction along which collision with the obstacles can be prevented, so that the transport robot can drive while avoiding obstacles that are not on a fixed map.

Effects obtainable from the present embodiments are not limited by the above mentioned effects, and other unmentioned effects can be clearly understood from the above description by those having ordinary skill in the technical field to which the present disclosure pertains.

### DESCRIPTION OF DRAWINGS

FIG. 1 is a diagram illustrating a cloud system based on a 5G network according to an embodiment of the present disclosure.

FIG. 2 is a block diagram illustrating appearance of a transport robot according to an embodiment of the present disclosure.

FIG. 3 is a diagram illustrating a robot control system according to an embodiment of the present disclosure.

FIG. 4 is a perspective view illustrating a transport robot according to an embodiment of the present disclosure.

FIG. 5 is a drawing illustrating internal components of the transport robot according to an embodiment of the present disclosure.

FIG. 6 is a diagram illustrating a transport means according to an embodiment of the present disclosure.

FIG. 7 is a diagram illustrating example positions of a trailer that moves along a driving path of the transport robot according to an embodiment of the present disclosure.

FIG. 8 is a diagram illustrating a connection unit of the transport means according to an embodiment of the present disclosure.

FIG. 9 is a cross-sectional view illustrating the structure taken along line the A-A of FIG. 8.

FIG. 10 is a diagram illustrating a rotation range of a rotation bracket according to an embodiment of the present disclosure.

FIGS. 11 to 13 are flowcharts illustrating examples of a method for controlling the transport robot according to the present disclosure.

FIGS. 14 and 15 are diagrams schematically illustrating the movement of the transport means according to an embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A robot is a machine device capable of automatically performing a certain task or operation. The robot may be controlled by an external control device or may be embedded in the control device. The robot may perform tasks that are difficult for humans to perform, such as repeatedly processing only a preset operation, lifting a heavy object, performing precise tasks or a hard task in extreme environments.

In order to perform such tasks, the robot includes a driver such as an actuator or a motor, so that the robot may perform various physical operations, such as moving a robot joint.

Industrial robots or medical robots having a specialized appearance for specific tasks due to problems such as high manufacturing costs and dexterity of robot manipulation were the first to be developed.

Whereas industrial and medical robots are configured to repeatedly perform the same operation in a designated place, mobile robots have recently been developed and introduced to the market. Robots for use in the aerospace industry may perform exploration tasks or the like on distant planets that are difficult for humans to directly go to, and such robots have a driving function.

In order to perform the driving function, the robot has a driver, wheel(s), a frame, a brake, a caster, a motor, etc. In order for the robot to recognize the presence or absence of surrounding obstacles and move while avoiding the surrounding obstacles, an evolved robot equipped with artificial intelligence has recently been developed.

Artificial intelligence refers to a technical field for researching artificial intelligence or a methodology for implementing the artificial intelligence. Machine learning refers to a technical field for defining various problems handled in the artificial intelligence field and for researching methodologies required for addressing such problems. Machine learning is also defined as an algorithm that improves performance of a certain task through continuous experience.

An artificial neural network (ANN) is a model used in machine learning, and may refer to an overall model having problem solving ability, which is composed of artificial neurons (nodes) that form a network by a combination of synapses. The artificial neural network (ANN) may be defined by a connection pattern between neurons of different layers, a learning process of updating model parameters, and an activation function of generating an output value.

The artificial neural network (ANN) may include an input layer and an output layer, and may optionally include one or more hidden layers. Each layer includes one or more neurons, and the artificial neural network (ANN) may include a synapse that interconnects neurons and other neurons.

In the artificial neural network (ANN), each neuron may output a function value of an activation function with respect to input signals received through synapses, weights, and deflection.

A model parameter may refer to a parameter determined through learning, and may include the weight for synapse connection and the deflection of neurons. In addition, the hyperparameter refers to a parameter that should be set before learning in a machine learning algorithm, and includes a learning rate, the number of repetitions, a mini-batch size, an initialization function, and the like.

The purpose of training the artificial neural network (ANN) may be seen as determining model parameters that minimize a loss function according to the purpose of the robot or the field of use of the robot. The loss function may be used as an index for determining an optimal model parameter in a learning process of the artificial neural network (ANN).

Machine learning may be classified into supervised learning, unsupervised learning, and reinforcement learning according to learning methods.

Supervised learning refers to a method for training the artificial neural network (ANN) in a state where a label for learned data is given. Here, the label may refer to a correct answer (or a resultant value) that should be inferred by the artificial neural network (ANN) when the learned data is input to the artificial neural network (ANN). Unsupervised learning may refer to a method for training the artificial neural network (ANN) in a state where a label for learned data is not given. Reinforcement learning may refer to a learning method in which an agent defined in the certain environment learns to select an action or sequence of actions that may maximize cumulative compensation in each state.

Among artificial neural networks, machine learning implemented as a deep neural network (DNN) including a plurality of hidden layers is also referred to as deep learning, and deep learning is a part of machine learning. Hereinafter, machine learning is used in a sense including deep learning.

Artificial intelligence (AI) technology is applied to the robot, so that the robot may be implemented as a guide robot, a transport robot, a cleaning robot, a wearable robot, an entertainment robot, a pet robot, and an unmanned aerial robot, etc.

The robot may include a robot control module for controlling operation thereof, and the robot control module may refer to a software module or a chip implemented in hardware.

By means of sensor information obtained from various types of sensors, the robot may acquire state information of the robot, may detect (recognize) the surrounding environment and the object, may generate map data, may determine a driving path and a driving plan, may determine a response to user interaction, or may determine a necessary operation.

The robot may perform the above-described operations using a learning model composed of at least one artificial neural network (ANN). For example, the robot may recognize the surrounding environment and object using a learning model, and may determine a necessary operation using the recognized surrounding environment information or object information. Here, the learning model may be directly learned from the robot or learned from an external device such as an AI server.

In this case, whereas the robot may perform a necessary operation by directly generating a result using the learning model, the robot may also perform an operation by transmitting sensor information to an external device such as an AI server and receiving the resultant information generated thereby.

The robot may perform autonomous driving through artificial intelligence. Autonomous driving refers to a technique in which a movable object such as a robot may autonomously determine an optimal path by itself and may move while avoiding collision with an obstacle. The autonomous driving technique currently being applied may include a technique in which the movable object (e.g., a robot) may travel while maintaining a current driving lane, a technique in which the movable object may travel while automatically adjusting a driving speed such as adaptive cruise control, a technique in which the movable object may automatically travel along a predetermined path, and a driving technique in which, after a destination is decided, a path to the destination is automatically set.

In order to perform autonomous driving, the movable object such as the robot may include a large number of sensors to recognize data of the surrounding situation. For example, the sensors may include a proximity sensor, an illumination sensor, an acceleration sensor, a magnetic sensor, a gyro sensor, an inertial sensor, an RGB sensor, an infrared (IR) sensor, a fingerprint recognition sensor, an ultrasonic sensor, an optical sensor, a microphone, a Lidar, a radar, and the like.

The robot may perform autonomous driving not only based on information collected by sensors, but also based on image information collected by an RGBC camera and an infrared (IR) camera and sound information collected through a microphone. In addition, the robot may travel based on information received through a user input unit. Map data, position information, and information about peripheral situations may be collected through a wireless communication unit. The collected information is requisite for autonomous driving.

Map data may include object identification information for various objects disposed in a space where the robot moves. For example, the map data may include object identification information for fixed objects such as a wall and a door, and other object identification information for movable objects such as a flowerpot and a desk. In addition, the object identification information may include a name, a type, a distance, a location, etc.

Therefore, the robot may essentially include sensors, various input units, a wireless communication unit, and the like to collect data that may be learned by artificial intelligence, and may perform optimal operations by synthesizing various types of information. The learning processor for performing artificial intelligence may perform learning by being mounted in a controller embedded in the robot, may transmit the collected information to a server, may perform learning through the server, and may retransmit the learned result to the robot, so that the robot may perform autonomous driving based on the learned result.

A robot equipped with artificial intelligence may collect the surrounding information even in a new place to implement the entire map, and a large amount of information about a place of the major activity zone may be accumulated, so that the robot may perform more accurate autonomous driving.

The robot may include a touchscreen or a button to receive a user input, and may receive a command by recognizing a user's voice. In order to convert a voice input signal into a character string, the processor may obtain information about the intention corresponding to the user input using at least one of a speech to text (STT) engine for converting a voice input into a character string and a natural language processing (NLP) engine for obtaining information about the intention of natural language.

In this case, at least one of the STT engine and the NLP engine may include an artificial neural network (ANN) trained by a machine learning algorithm. In addition, at least one of the STT engine and the NLP engine may be trained by the learning processor, may be trained by the learning processor of the AI server, or may be trained by distributed processing of the trained results.

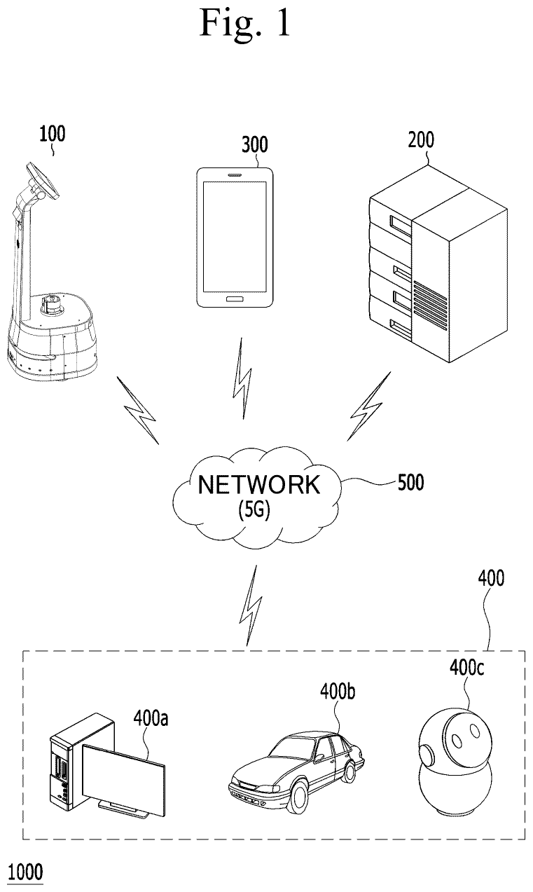

FIG. 1 is a diagram illustrating a cloud system 1000 based on a 5G network according to an embodiment of the present disclosure.

Referring to FIG. 1, the cloud system 1000 may include a transport robot 100, a mobile terminal 300, a robot control system 200, various devices 400, and a 5G network 500.

The transport robot 100 is a robot that transports goods (articles) from a departure point to a destination. The transport robot 100 can move directly from a logistics center to a destination. Alternatively, after the transport robot is loaded on a vehicle at the logistics center and is then delivered to the vicinity of the destination by the vehicle, the transport robot is unloaded from the vehicle and then moves to the destination.

In addition, the transport robot 100 may move articles to the destination not only outdoors but also indoors. The transport robot 100 can be implemented as an AGV, and the AGV may be a transport device that moves by a sensor, a magnetic field, a vision device, etc. on the floor.

The transport robot 100 may include a storage area for storing articles therein, the storage area may be divided into a plurality of partial storage areas to load various articles, and various types of articles may be placed in the partial storage areas. Accordingly, mixing of articles can be prevented.

The mobile terminal 300 may communicate with the transport robot 100 via the 5G network 500. The mobile terminal 300 may be a device carried by a user who installs a partition in the storage area to load articles, or may be a device carried by a recipient of the loaded articles. The mobile terminal 300 may provide information based on images, and the mobile terminal 300 may include mobile devices such as a mobile phone, a smartphone, a wearable device (e.g., a watch-type terminal, a glass-type terminal, an HMD).

The robot control system 200 may remotely control the transport robot 100 and respond to various requests of the transport robot 100. For example, the robot control system 200 may perform calculations using artificial intelligence (AI) based on the request from the transport robot 100.

In addition, the robot control system 200 may determine a movement path of the transport robot 100. When there is a plurality of destinations, the robot control system 200 may determine the order of the destinations when there are multiple destinations.

The various devices 400 may include a personal computer (PC) 400a, an autonomous vehicle 400b, a home robot 400c, etc. When the transport robot 100 arrives at the transport destination of the articles, the transport robot 100 can directly deliver the articles to the home robot 400c through communication with the home robot 400c.

The various devices 400 may be connected to the transport robot 100, the mobile terminal 300, the robot control system 200, etc., via the 5G network 500 by wire or wirelessly.

The transport robot 100, the mobile terminal 300, the robot control system 200, and various devices 400 are all equipped with 5G modules to transmit and receive data at a rate of 100 Mbps to 20 Gbps (or higher), so that large video files can be transmitted to various devices, and power consumption can be minimized by operating at low power. However, the transfer rate may be implemented differently depending on the embodiments.

The 5G network 500 may include a 5G mobile communication network, a short-range network, the Internet, etc., and may provide a communication environment for devices by wire or wirelessly.

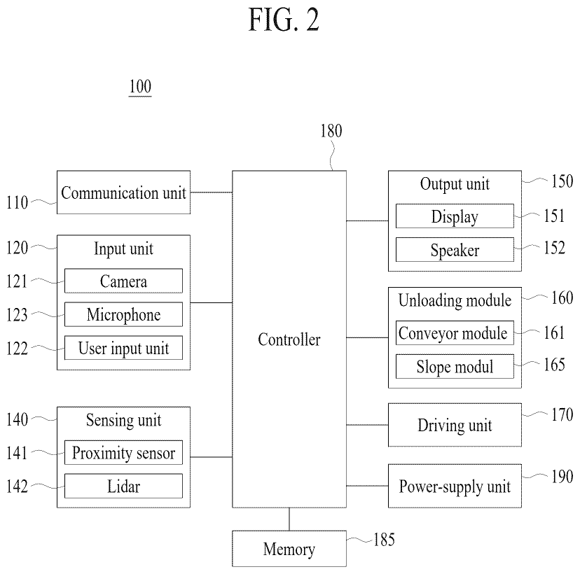

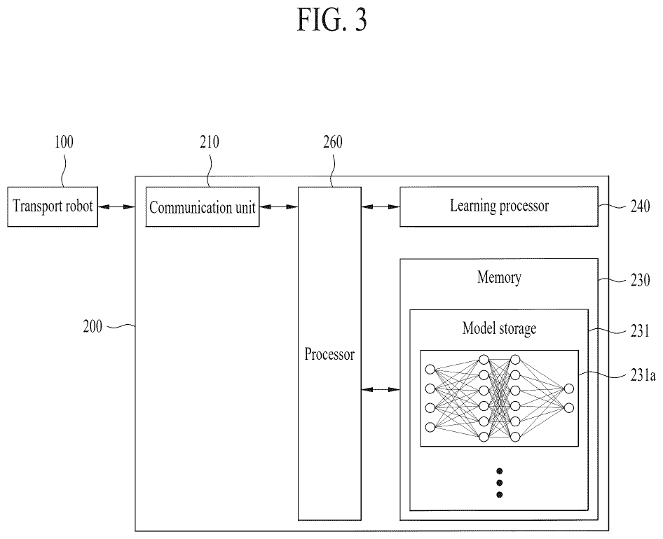

FIG. 2 is a block diagram illustrating appearance of the transport robot 100 according to an embodiment of the present disclosure. The transport robot 100 according to an embodiment of the present disclosure will be described with reference to FIGS. 3 to 5.

Referring to FIG. 2, the transport robot 100 may include a body including a storage area 50, and constituent components to be described later may be included in the body. The transport robot 100 may include a communication unit 110, an input unit 120, a sensor unit 140, an output unit 150, a memory 185, a wheel driving unit 170, a controller 180, and a power-supply unit 190. The constituent components shown in FIG. 2 are not always required to implement the transport robot 100, such that it should be noted that the transport robot 100 according to the present disclosure may include more or fewer components than the elements listed above.

The communication unit 110 may include a wired or wireless communication module capable of communicating with the robot control system 200.

As an optional embodiment, the communication unit 110 may be equipped with modules for GSM, CDMA, LTE, 5G, WLAN, Wi-Fi, Bluetooth, RFID, infrared communication (IrDA), ZigBee, and NFC communication.

The input unit 120 may include a user input unit 122 for receiving information from a user. As an optional embodiment, the input unit 120 may include a camera 121 for inputting an image signal, and a microphone 123 (hereinafter referred to as a “microphone”) for receiving an audio signal. Here, the camera 121 or the microphone 123 may be treated as a sensor, and a signal acquired from the camera 121 or the microphone 123 may be referred to as sensing data or sensor information.

The input unit 120 may acquire input data to be used when acquiring output data using learning data and a learning model for model learning. The input unit 120 may obtain unprocessed input data. In this case, the controller 180 may extract input feature points as preprocessing for the input data.

The camera 121 may be located in front to detect obstacles in front, and as shown in FIG. 3, a plurality of cameras 121 may be arranged to be different in angle. In more detail, the plurality of cameras 121 may have different capture directions, such as a camera for widely recognizing a front-view area and a camera for capturing a floor.

Alternatively, cameras with different functions may be provided. For example, a wide-angle camera, an infrared (IR) camera, etc. may be provided. The camera may serve as a sensor unit 140 for detecting surrounding objects.

The user input unit 122 may be provided with a touch panel overlapping with a button or a display 151. Alternatively, a user command may be input remotely through the communication unit 110. In this case, the user input unit 122 may include a PC 400 or a remote control device separately provided from the transport robot 100.

Since the user input unit 122 includes all methods capable of receiving user commands, the user input unit 122 can recognize user commands through voice recognition. That is, a voice recognition device that analyzes voice collected from the microphone 123 and extracts user commands can also serve as the user input unit 122.

The input unit 120 may include an article information input unit, and the article information input unit may receive information about the article's size, information about the article's weight, destination information, information about a transport requester, etc. At this time, the article information input unit may include a code reader.

The sensor unit 140 may obtain at least one of internal information of the transport robot 100, surrounding environment information of the transport robot 100, and user information using various sensors.

At this time, the sensor unit 140 may include various types of sensors for recognizing the surroundings for autonomous driving. Representative examples may include a distance detection sensor or a proximity sensor 141 and a Lidar 141.

The proximity sensor 141 may include an ultrasonic sensor that recognizes nearby objects and determines the distance to the objects based on the time taken for emitted ultrasonic waves to return. A plurality of proximity sensors may be provided along the circumference, and may also be provided on an upper side to detect obstacles located on the upper side.

The Lidar 142 is a device that precisely expresses exterior appearances of the surroundings by emitting laser pulses and receiving the light that is reflected from the surrounding objects. The operation principle of the Lidar 142 is similar to that of a radar, but different electromagnetic waves are used in the Lidar 142 and the radar, so that the Lidar 142 and the radar are designed to use different technologies and different utilization ranges.

Lasers may damage human eyesight because they use light with a wavelength of 600 to 1000 nm. The Lidar 142 uses a longer wavelength than the lasers, and is used to measure not only the distance to a target object, but also a moving speed and direction, temperature, surrounding atmospheric material analysis, a concentration measurement, and the like.

In addition, the sensor unit 140 may include an illumination sensor, an acceleration sensor, a magnetic sensor, a gyro sensor, an inertial sensor, an RGB sensor, an infrared (IR) sensor, a fingerprint recognition sensor, an ultrasonic sensor, a light sensor, an optical sensor, etc.

The output unit 150 may generate various output signals related to visual, auditory and/or tactile sensations. The output unit 150 may include an optical output unit that outputs visual information, a display 151, etc. The output unit 150 may include a speaker 152 for outputting auditory information, an ultrasonic output unit for outputting ultrasonic signals belonging to an inaudible frequency, etc., and a haptic module for outputting tactile information.

The memory 185 may store data that supports various functions of the transport robot 100. The memory 185 may store not only a plurality of application programs (or applications) driven by the transport robot 100, but also data and commands required to operate the transport robot 100.

In addition, the memory 185 may store information required to perform operations using artificial intelligence, machine learning, and artificial neural networks. The memory 185 may store a deep neural network model. The deep neural network model may be used to infer a result value for new input data rather than learning data, and the inferred value may be used as a basis of determination required to perform a certain operation.

The power-supply unit 190 may receive external power or internal power under control of the controller 180, such that the power-supply unit 190 may supply the received power to the constituent components included in the transport robot 100. The power-supply unit 190 may include, for example, a battery. The battery 191 may be implemented as an embedded battery or a replaceable battery. The battery may be charged by a wired or wireless charging method, and the wireless charging method may include a magnetic induction method or a magnetic resonance method.

The driving unit 170 is a means for moving the transport robot 100, may include wheels or legs, and may include a wheel driving unit and a leg driving unit for controlling the wheels or legs.

A plurality of wheels provided on the bottom surface of the wheel driving unit may be controlled to move the transport robot 100 including the body. The wheels may include a main wheel 171 for fast driving, a caster 173 for changing the direction to another direction, and an auxiliary caster for stable driving so that the loaded articles (L) do not fall during driving.

The leg driving unit (not shown) may control multiple legs according to control of the controller 180, and may thus move the body. The plurality of legs may correspond to a configuration formed so that the transport robot 100 can walk or run. The plurality of legs may be implemented as four legs, but the scope of the present disclosure is not limited thereto. The plurality of legs may be coupled to the body to be integrally formed, and may be implemented to be detachably coupled to the body.

The transport robot 100 may move the body through the driving unit 170 having at least one of the wheel driving unit and/or the leg driving unit. However, in this specification, an example in which the wheel driving unit is mounted on the transport robot 100 will be mainly described.

The controller 180 is a module that controls the configurations of the transport robot 100. The controller 180 may refer to a data processing device embedded in hardware that has a physically structured circuit to perform a function expressed by code or commands included in a program. As an example of the data processing device embedded in hardware, this exemplary data processing device may include processing devices such as a microprocessor, a central processing unit (CPU), a processor core, a multiprocessor, an ASIC, and an FPGA, but the scope of the present disclosure is not limited thereto.

For example, the controller 180 may collect the above information through the input unit 120. The input of the input unit 120 may also include a touch input on the display.

Based on the collected information, the controller 180 may transmit information on the articles (L) loaded in the loading area 50 to the mobile terminal 200 (see FIG. 1) through the communication unit 110.

Referring to FIG. 3, the robot control system 200 may include an artificial intelligence (AI) server. The AI server may mean a device that uses a machine learning algorithm to train an artificial neural network or uses a trained artificial neural network. Here, the robot control system 200 may include a plurality of servers to perform distributed processing, and may be defined as a 5G network. At this time, the AI server may be included as a part of the configuration of the transport robot 100, and may also enable the transport robot 100 to perform at least a part of the AI processing.

The robot control system 200 may include a communication unit 210, a memory 230, a learning processor 240, a processor 260, etc.

The communication unit 210 may transmit and receive data to and from an external device such as the transport robot 100.

The memory 230 may include a model storage unit 231. The model storage unit 231 may store a learning or learned model (or an artificial neural network 231a) through the learning processor 240.

The learning processor 240 may train (or learn) the artificial neural network 231a using training data (also called learning data). The learning model may be used while being loaded into the robot control system 200 of the artificial neural network, or may be loaded into an external device such as the transport robot 100 and then used.

The learning model may be implemented as hardware, software, or a combination of hardware and software. If all or some of the learning model are implemented as software, one or more commands constituting the learning model can be stored in the memory 230.

The processor 260 may infer a result value for new input data using the learning model, and may generate a response or control command based on the inferred result value.

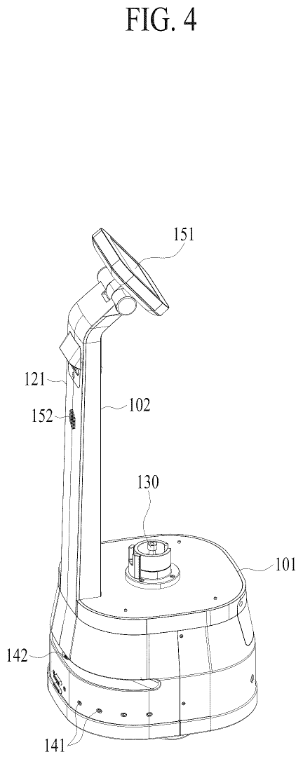

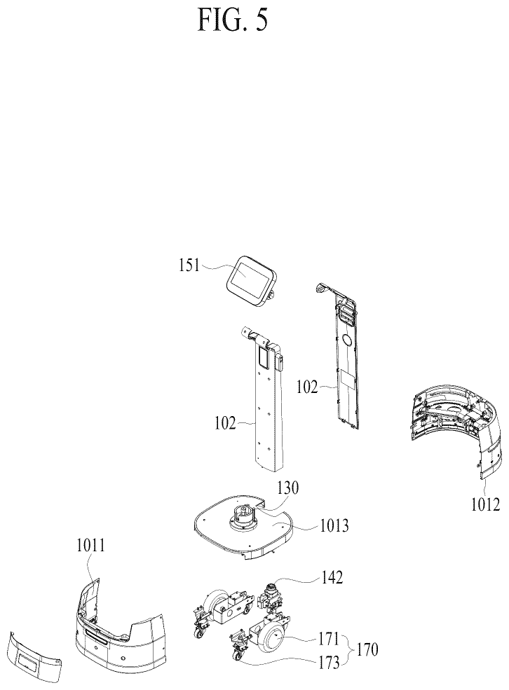

FIG. 4 is a perspective view illustrating the transport robot 100 according to an embodiment of the present disclosure. FIG. 5 is a drawing illustrating internal components of the transport robot 100 according to an embodiment of the present disclosure.

The transport robot 100 according to the present disclosure may move through the driving unit 170 located at the bottom of the body 101. Since the main body of the transport robot 100 has a box-shaped form and there is no area for loading articles, the body 101 may have a flat shape as long as only some components such as the driving unit 170, battery 191, and board assembly 181 can be seated therein.

However, for convenience of use, the display 151 may be placed at a position spaced apart from the upper side of the body 101 through a vertical bracket 102 in consideration of the eye height of the user. The display 151 may include a touch sensor to function as an input unit, and the user may input a destination and change the function settings of the transport robot 100 through the display 151.

Since the trailer 600 is located in the opposite direction of the driving direction, the connector 630 of the trailer 600 coupled to the trailer 600 is connected in the opposite direction of the driving direction.

Therefore, the vertical bracket 102 where the display 151 is positioned may be positioned in the front direction of the driving direction so as not to interfere with the connector 630 of the trailer 600.

The vertical bracket 102 may be designed to include the display 151, and may include a camera or a sensor. Considering the height of the trailer 600, it is necessary to detect the presence or absence of an obstacle up to the top of the trailer 600. Since the detectable range is expanded when the camera or sensor is located in the upper direction, the vertical bracket 102 may be used to place the camera and sensor at a certain height.

The transport robot according to the present embodiment may include a camera positioned at a predetermined height, and the camera may be implemented as a pair of cameras including a first camera facing the front and a second camera located obliquely downward.

A speaker 152 may be further provided to provide a warning sound or notification to the user and may be located on the vertical bracket 102 in consideration of the position of the user's ears.

The Lidar 142 and the proximity sensor 141 may be located in the body 101. Since the Lidar has a wide sensing range, a long groove may be included in the horizontal direction as shown in FIG. 4 to expand the sensing range of the Lidar 142.

The proximity sensor 141 may be implemented as multiple numbers that are arranged along the circumference of the body 101 to precisely detect the position. Since the obstacles in the driving direction are mainly problematic and the trailer 600 is located at the rear of the transport robot, the proximity sensor can be located only at the front of the transport robot.

Referring to FIG. 5, the components located inside the body 101 may be confirmed. The body 101 has a frame for mounting the components therein, and the driving unit 170 is located at the bottom of the frame, and components such as the substrate assembly 181, the battery 191, and the Lidar 142 are mounted on the upper part of the frame.

The main wheel 171 constituting the driving unit 170 is connected to a motor to directly transmit driving force, and the speed of the motor may be adjusted to control the speed of the transport robot 100.

The caster 173 may include an axle, which is a rotation axis of the wheel, and a main shaft that is arranged perpendicular to the axle and rotates about the body 101. The movement direction of a driving robot may be controlled using the caster 173, or the driving direction may be changed by adjusting the left and right rotation speed of the main wheel.

The body 101 may rotate in place by adjusting the direction of the caster 173, and this type of the driving unit 170 helps the transport robot 100 to move while avoiding obstacles within a limited space.

Since the battery 191 and the substrate assembly 181 occupy most of the weight of the transport robot 100, they are located at the bottom of the transport robot 100 so that the transport robot 100 can move stably.

The transport robot 100 may also be implemented as a specific type of transport robot that can load articles thereon, but the transport robot 100 according to the present disclosure is a transport robot that is connected to a trailer 600 loaded with articles and tows the trailer 600.

Referring to FIG. 4, a connector holder 130 for fastening a connector 630 of the trailer 600 to the body 101 may be provided in the transport robot 100. Since the height of the body 101 is low due to the absence of a separate loading space in the transport robot, the connector holder 130 may be located on the body 101, and in some cases, the connector holder 130 may also be located on the rear side of the body 101.

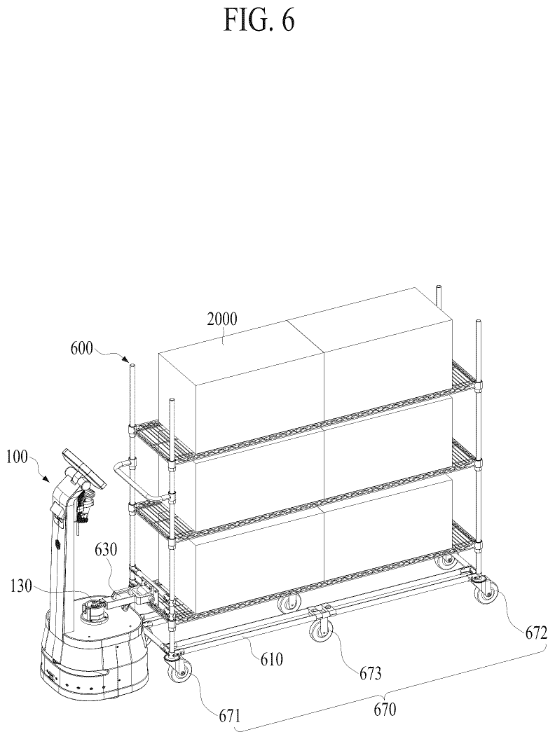

FIG. 6 is a diagram illustrating a transport means according to an embodiment of the present disclosure. In FIG. 6, the transport means refers to both the transport robot 100 and the trailer 600.

As shown in FIG. 6, the trailer 600 may include a loading space located at an upper part thereof, and may have a layered structure to stably load a large quantity of articles.

When the transport robot moves indoors or in a limited space, the moving speed of the transport robot is not high, and the trailer 600 composed only of a frame having no sidewall may be used to facilitate loading and unloading of articles.

A connector 630 located on one side of the trailer 600 is coupled to the connector holder 130 of the transport robot 100, and may move in the driving direction of the transport robot 100.

The trailer 600 may include multiple wheels 670 at the bottom of the frame. The wheels 670 may include four casters (671, 672) located on at least four corners for stable transportation.

The wheels 670 of the trailer 600 may have a caster shape so that they can move naturally in the direction of movement of the transport robot 100. Since the main shaft of the caster is located obliquely from the axle, the wheels 670 can rotate naturally in the direction of the frame 610.

In addition to the four corners, an auxiliary wheel 673 may be additionally provided in the middle in the longitudinal direction. The auxiliary wheel 673 may supplement the supporting force of the frame 610 when the trailer 600 becomes longer in one direction, and the center of rotation may change due to the auxiliary wheel 673.

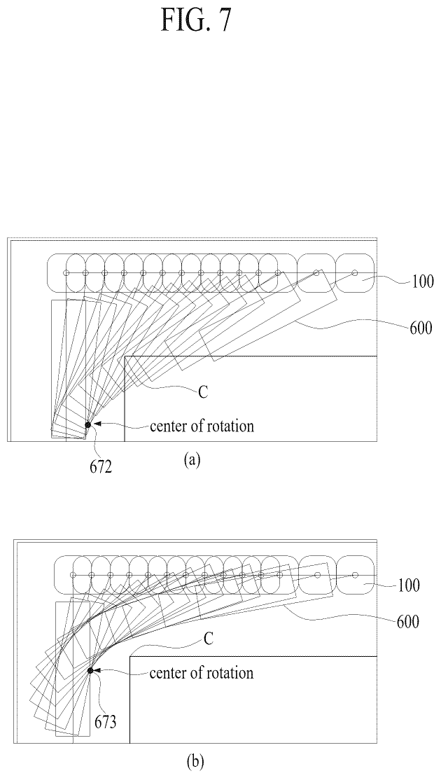

FIG. 7 is a diagram illustrating example positions of the trailer 600 that moves along a driving path of the transport robot 100 according to an embodiment of the present disclosure. Referring to FIG. 7, the moving path of the trailer 600 may change depending on the presence or absence of the auxiliary wheel 673. FIG. 7(a) shows the trailer 600 that does not include the auxiliary wheel 673, and FIG. 7(b) shows the trailer 600 that includes the auxiliary wheel 673.

Referring to FIG. 7(a), when the transport robot 100 changes the movement direction by 90° at the corner and then moves to the right, the trailer 600 rotates around the right rear wheel 672. Since the trailer 600 is connected to the transport robot 100, the position of the right rear wheel 672 moves slightly, but the angle of the trailer 600 changes around the rear wheel 672 in the direction of rotation.

In this case, since the turning radius increases, the trailer 600 may collide with the corner (C), so that the driving path must be designed to secure enough space in the turning direction (e.g., the right direction in the present embodiment) to rotate.

Referring to FIG. 7(b), since the trailer 600 rotates around the auxiliary wheel 673 located at the center thereof, the turning radius of the trailer 600 is smaller than in the case of FIG. 7(a) where the auxiliary wheel 673 is not present. Therefore, there is an advantage in that the transport robot 100 can rotate without colliding with the corner (C) in a narrow space.

However, since the trailer 600 located at the rear of the auxiliary wheel 673 protrudes farther leftward than the left position of the trailer 600, it is necessary to design a driving path that secures more space in the opposite direction (i.e., left direction in the present embodiment) of the rotation direction.

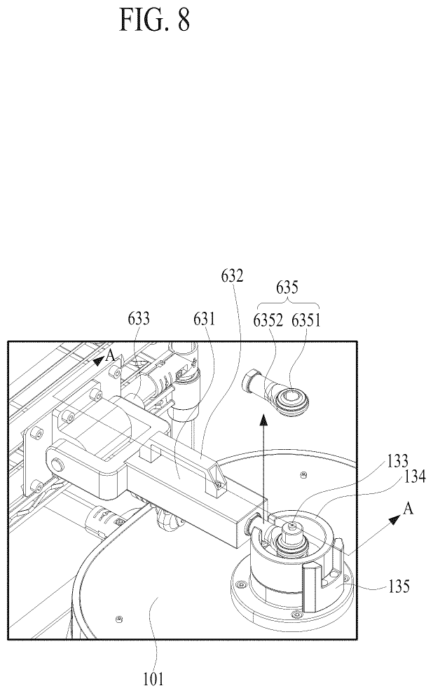

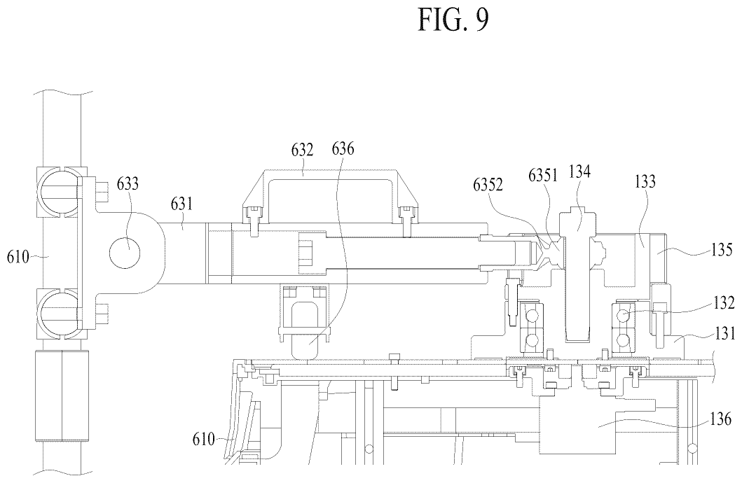

FIG. 8 is a diagram illustrating connection units (130, 630) of the transport means (100, 600) according to an embodiment of the present disclosure. FIG. 9 is a cross-sectional view illustrating the structure taken along line the A-A of FIG. 8.

The connector 630 of the trailer 600 may be located at the front of the trailer 600, and may be hinged to the frame 610 of the trailer 600 so as to be rotatable about a horizontal axis. Regardless of the height of the transport robot 100, the transport robot 100 may be coupled to the connector holder 130 of the transport robot 100.

The connector 630 may include a rod-end bearing 635 that includes a bar-shaped connection bracket. One end of the connection bracket may be hinged to the frame of the trailer 600 and the other end of the connection bracket may be provided with a rod-end bearing 635 for connection to the connector holder 130.

The rod-end bearing 635 may include an inner bearing 6351 that forms a coupling hole by penetrating a sphere and an outer bearing that has an inner surface corresponding to a curved surface of the inner bearing 6351. Since the inner bearing 6351 has the curved surface forming a part of the sphere, the coupling hole of the inner bearing 6351 may rotate about three axes (i.e., may perform three-axis rotation). Even if the height of the connector holder 130 of the transport robot 100 is different from that of the connector 630, the transport robot 100 can be coupled to the connector 630 and can rotate and drive on an inclined surface.

An auxiliary roller 636 may be provided at the bottom of the connection bracket. The auxiliary roller 636 may contact the top surface of the transport robot 100, and may serve as a cushion that prevents the connection bracket from colliding with the top surface of the transport robot 100 and also prevents the transport robot 100 from being damaged. In addition, when the driving direction of the transport robot 100 changes, the angle of the transport robot 100 and the angle of the trailer 600 change. At this time, the connection bracket may be provided in a wheel shape so as not to interfere with the rotation of the connection bracket.

The auxiliary robot 636 may be rotatable about the axis parallel to the extension direction of the connection bracket, and may assist the rotation of the connection bracket without interfering with the rotation of the connection bracket.

The connector holder 130 of the transport robot 100 may include a fixed bracket 131 coupled to the main body of the transport robot 100; and a rotation bracket 133 rotatably coupled to the fixed bracket 131. A rolling bearing 132 may be provided for rotation between the fixed bracket 131 and the rotation bracket 133.

The connector 630 may be coupled to the rotation bracket 133 using a fastening pin 134. The fastening pin 134 may be inserted into the coupling hole of the inner bearing 6351 of the rod-end bearing 635, and may be fixed to the rotation bracket 133.

However, since the rod-end bearing 635 of the connector 630 can rotate along three axes, it can also rotate about a rotation coupling unit in a vertical direction. Therefore, the rotation bracket 133 may have a sidewall formed to surround the horizontal left and right sides of the connector 630 so that the rotational coupling unit and the connector 630 do not rotate separately.

Therefore, the connector 630 and the rotation bracket 133 simultaneously rotate by the same angle, and the trailer 600 can move stably along the transport robot 100 without shaking.

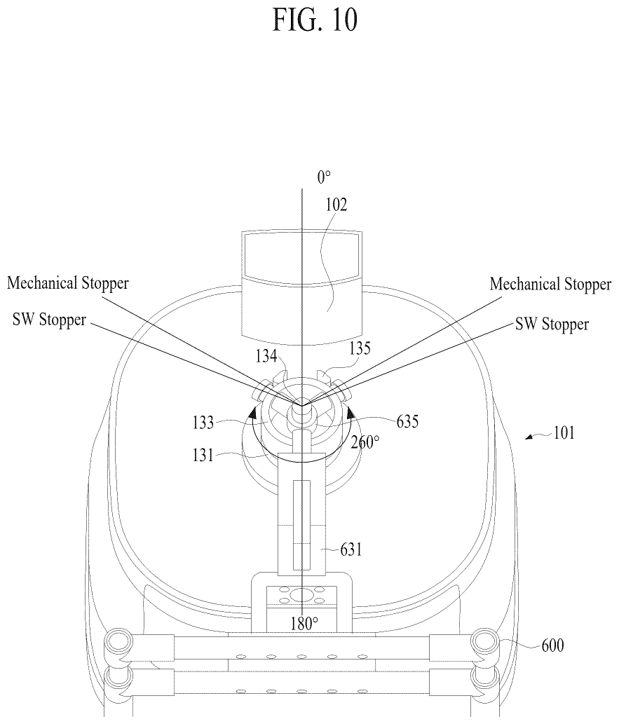

FIG. 10 is a diagram illustrating a rotation range of the rotation bracket 133 according to an embodiment of the present disclosure. When the trailer 600 is located in front of the driving direction, the transport robot has difficulty in driving and the vertical bracket 102 may be damaged, so that a stopper 135 that restricts the rotation of the rotation bracket 133 within a certain range may be further included.

The stopper 135 may have a shape that comes into contact with the rotation bracket 133, or may have a shape that comes into contact with the connector 630 to restrict rotation of the rotation bracket 133 as shown in FIG. 10.

The transport robot 100 according to the present disclosure can detect the amount of rotation of the rotation bracket 133 and may restrict the rotation of the rotation bracket 133 through software. However, when the trailer 600 is heavy or rotates at a high speed, it may rotate by a limited angle or more of the software control method.

In order to address the above-described issues, a physical stopper 135 may be provided, and the position of the stopper 135 may be set so that the rotation bracket 133 can rotate up to an angle slightly larger than the limit angle on the software.

The stopper 135 may be located at the driving direction side with respect to the rotation bracket 133, and may be provided to be bilaterally symmetrical with respect to the driving direction.

The connector holder 130 may further include an encoder 136 that detects the rotation amount of the rotation bracket 133. The encoder 136 is a sensor that detects the rotation speed or direction, may detect the rotation amount of the rotation bracket 133, and may transmit the detected result to the controller 180.

The controller 180 may estimate the position of the trailer 600 based on the rotation amount detected by the encoder 136. The angle of the connector 630 may be estimated based on the amount of rotation of the rotation bracket 133, and the position of the trailer 600 may be calculated based on information about the size (length and width) of the trailer 600 coupled to the connector 630.

The controller 180 of the transport robot 100 may track the position of the trailer 600 in real time using the encoder 136, so that the driving path can be modified and driven even when a driving path changes or in an unexpected situation.

A method for controlling the transport robot 100 equipped with an encoder so that the transport robot 100 estimates the position of the trailer 600, calculates a new driving path and speed, and pulls and transports the trailer 600 will hereinafter be described in detail.

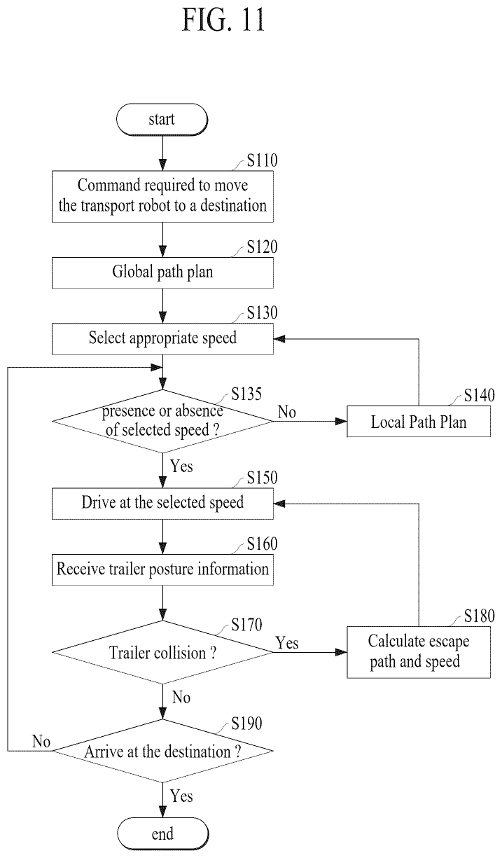

FIGS. 11 to 13 are flowcharts illustrating examples of a method for controlling the transport robot 100 according to the present disclosure.

Referring to FIG. 11, the entire flowchart for controlling the transport robot 100 to move to a destination is shown. When the controller 180 receives a command for moving the transport robot 100 to the destination (S110), the controller 180 may establish the global path plan (S120).

The destination may be input through the user input unit, or may be input through the robot control system 200 or the terminal 300 via remote control.

The entire route (hereinafter referred to as a global path) may be designed based on fixed map information to the destination in advance. For example, in the case of a warehouse, the global path plan may be established by utilizing fixed map information including the positions of the warehouse walls and previously installed racks.

The global path plan may be set with the shortest distance to the destination as a priority, but in areas with many curves or in narrow spaces, the transport robot may have difficulty in moving together with the trailer 600, so that it is possible to design a short path along which the transport robot can easily move while considering such difficulty.

In addition, since the transport robot 100 does not move alone in the curved section, the global path must be designed by considering the length and width of the trailer 600, and as shown in FIG. 7, the turning radius varies depending on the position and number of wheels, so that it is necessary to establish the global path plan by considering the changed turning radius. In other words, the global path plan varies depending on the type of connected trailer 600.

The target speed required to move the transport robot according to the global path plan may be calculated (S130). The speed of the transport robot may be determined by considering the size and weight of the connected trailer 600 and the characteristics of the loaded articles. If the trailer 600 is heavy, the centrifugal force increases when the trailer 600 rotates. In this case, when the path is changed at a high speed, the articles may fall.

The appropriate speed may be calculated using a dynamic window approach (DWA). The DWA is an algorithm that selects a speed that can quickly reach a target point while avoiding obstacles that may collide with the robot in the robot's velocity search space. DWA may change the existing position and speed area into a speed-angular velocity area, and thus can recognize a maximum speed and angular velocity by considering the robot's speed, direction, and collision.

However, since there are other obstacles that are not displayed in the fixed map information, the transport robot is unable to move along the global path, so that the appropriate speed may not be calculated. For example, in a situation where there are loaded articles or another trailer 600 is parked, if the transport robot 100 cannot drive according to the global path plan, the appropriate speed calculated by the controller 180 through DWA becomes zero “0”.

If there is no selected appropriate speed (S135), a local path plan can be established (S140). The local path plan may calculate a path through which the transport robot can recognize the surrounding obstacles through sensors and can move without colliding with the recognized obstacles. In this case, this path to which the local path plan is applied will hereinafter be referred to as a modified path.

The modified path is a path along which the transport robot can move to the destination while avoiding collision with obstacles. Since the transport robot can move while avoiding obstacles, the appropriate speed can be calculated through DWA (S130).

If the calculated appropriate speed exists (S135), the transport robot drives at the selected speed (S150). The transport robot 100 can receive posture information of the trailer 600 while driving at the selected speed (S160).

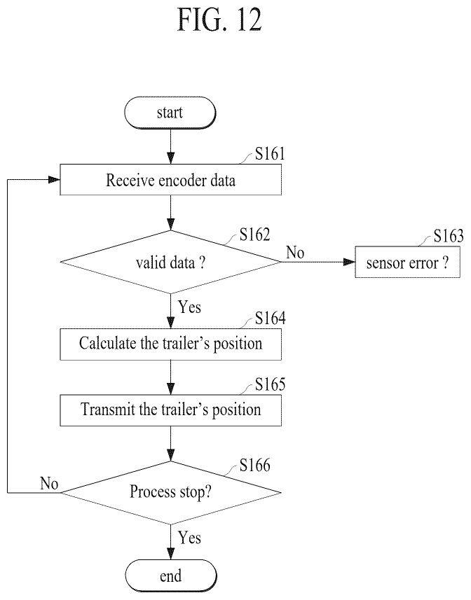

FIG. 12 is a flowchart illustrating a detailed procedure of a method for collecting posture information of the trailer 600. The trailer 600 may receive the angle data of the connector from the encoder 136 (S161). If the received data is invalid, occurrence of errors of the encoder (sensor) 136 is determined (S163), and the user can be notified of this defective sensor state.

If the data received from the encoder 136 is valid, the position/posture of the trailer 600 can be estimated based on this valid data (S164).

When the control method of FIG. 11 is performed by the transport robot 100, necessary data may be transmitted to the path planning module of the transport robot 100 (S165), so that the robot control system can calculate the path along which the transport robot can move while avoiding collision with the obstacles.

Calculating the position of the trailer 600 based on data of the encoder 136 may continue until the path planning and driving process are ended (S166).

The controller 180 may synthesize the posture information of the trailer 600 and obstacle-related data collected through sensors, and may calculate the distance between the trailer 600 and the surrounding obstacles based on the synthesized result. As a result, the controller 180 may determine whether the distance between the trailer 600 and the obstacle is a reference distance or less, so that the controller 180 may determine whether there is a high possibility that the trailer can collide with the obstacle or may determine whether the trailer collides with the obstacle (S170).

If the distance to the obstacle is equal to or greater than the reference distance and there is no risk of collision with the obstacle, the controller 180 may control the trailer 600 to move until reaching the destination (S190).

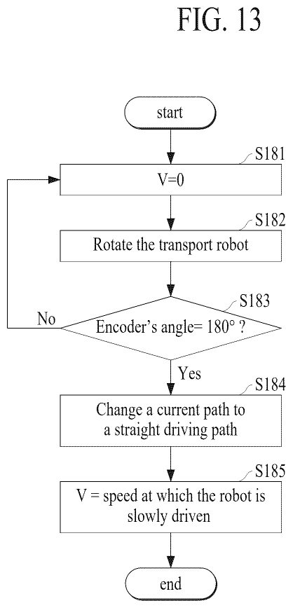

However, if the distance to the obstacle is within the reference distance and there is a risk of collision or such collision with the obstacle occurs, the path and speed for enabling the trailer to escape from the obstacle can be calculated (S180). A method for calculating the escape path and speed is specifically illustrated in FIG. 13.

Referring to FIG. 13, the speed is first set to zero “0” so that the transport robot 100 finishes movement (S181). The transport robot 100 rotates so that the angle of the encoder 136 becomes 180° (S182, S183). The transport robot 100 rotates so that the direction of the encoder 136 and the driving direction of the transport robot 100 are arranged parallel to each other. Finally, the transport robot 100 changes a current path to a straight driving path (S184).

When switching to the straight driving path, V (speed) is set to a predetermined speed (S185), so that the escape path and speed can be calculated. The controller 180 may drive along the modified escape path at the modified speed (S150), and may control the transport robot 100 to continuously move while monitoring occurrence or non-occurrence of such collision in real time.

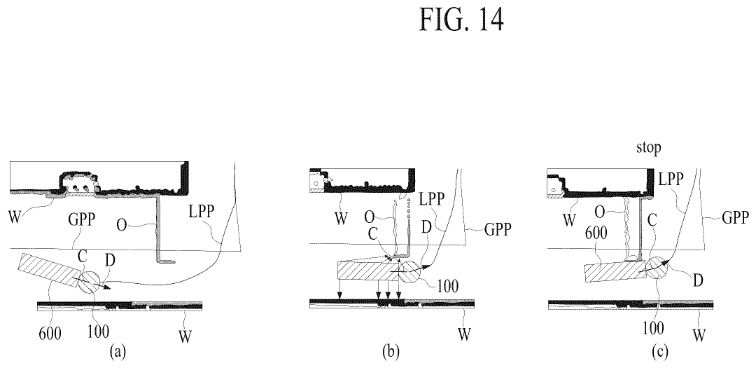

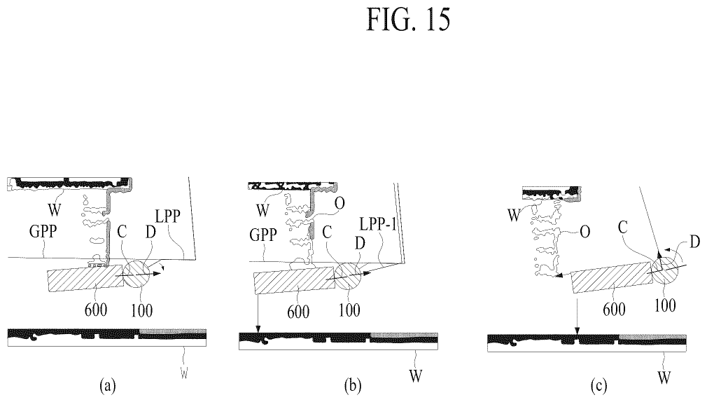

FIGS. 14 and 15 are diagrams schematically illustrating the movement of the transport means according to an embodiment of the present disclosure. In particular, as shown in FIGS. 14 and 15, when collision occurs, a method for collision stoppage is illustrated.

Referring to FIGS. 14 and 15, the arrow (D) of the transport robot 100 may indicate the driving direction of the transport robot 100, the straight line (C) between the transport robot 100 and the trailer 600 may indicate the connector 630, and the angle detected by the encoder 136 becomes the angle between the driving direction (D) and the connector 630 (C).

Referring to FIG. 14(a), the wall (W) is recorded in the fixed map information, and the global path plan (GPP) is established based on the recorded information (S10). However, since the obstacle (O) is detected, the transport robot can drive along a modified path according to a local path plan (LPP) while avoiding the obstacle (S140).

At this time, the position of the trailer 600 is received in real time (S160), and a new modified path (LLP) is created so that the transport robot can move along the new modified path (LLP) while avoiding the trailer 600, the obstacle (O), and the wall (W) existing on the fixed map (hereinafter, the obstacles may include the obstacle (O) detected by the sensor and another obstacle such as the wall (W) n on the fixed map).

As shown in FIG. 14(b), the transport robot 100 may calculate the position information of the trailer 600 based on the angle information of the encoder 136 of the trailer 600 while moving, and the trailer 600 searches for the distance to the obstacle (O, W) and at the same time continues to drive.

As shown in FIG. 14(c), if the transport robot 100 or the trailer 600 collides with the obstacle or approaches the obstacle within the reference distance and there is a high risk of collision, the transport robot 100 stops driving.

As shown in FIG. 15(a), after the transport robot 100 rotates so that the direction of the trailer 600 and the driving direction (D) are the same, the transport robot 100 drives in a straight direction in a manner that the trailer 600 and the transport robot 100 are arranged parallel to each other as shown in FIG. 15(b). At this time, the transport robot 100 drives while continuously monitoring the distance between the obstacle (O, W) and the trailer 600. When the trailer 600 is spaced apart from the obstacle (O, W) by a predetermined distance, the driving direction (D) is changed as shown in FIG. 15(c) so that the transport robot can move to the destination along any one path from among either the global path plan or the local path plan.

When the transport robot arrives at the destination that was initially entered, the transport robot may stop driving (S190).

The transport robot 100 can monitor the angle relative to the connected trailer 600 in real time, so that the position information of the connected trailer 600 can be secured in real time.

In addition, the distance between the trailer 600 having no sensor and the obstacle can be determined based on the position information of the trailer 600, so that the transport robot can control the connected trailer 600 to drive without colliding with the obstacle.

Even if there is a risk of collision, the transport robot can design an escape path in a direction along which collision with the obstacles can be prevented, so that the transport robot can drive while avoiding obstacles that are not on a fixed map.

The above detailed description is not to be construed as limiting in any respect and should be considered exemplary. The scope of the disclosure is to be determined by a reasonable interpretation of the appended claims, and all changes within the equivalents of the disclosure are included in the scope of the disclosure.

1. A transport robot comprising:
a body configured to include a driving unit; and
a connector holder located in the body and coupled to a connector of a trailer,
wherein the connector holder includes:
a fixed bracket fixed to the body;
a rotation bracket rotatably coupled to the fixed bracket;
a fastening pin configured to penetrate the connector of the trailer and fastened to the rotation bracket; and
an encoder configured to detect rotation of the rotation bracket.

2. The transport robot according to claim 1, further comprising:
at least one stopper located on one side of the rotation bracket and configured to limit a rotation range of the rotation bracket.

3. The transport robot according to claim 2, wherein:
the stopper is located on the rotation bracket in a driving direction of the driving unit, and provided to be bilaterally symmetrical with respect to the driving direction.

4. The transport robot according to claim 1, further comprising:
a controller configured to calculate position information of the trailer based on rotation amount data of the rotation bracket measured by the encoder.

5. The transport robot according to claim 4, wherein the controller is configured to:
calculate position information of the trailer based on the rotation amount data of the rotation bracket and information about a length and width of the trailer,
wherein
the position information of the trailer includes position information of four corners of a bottom surface of the trailer.

6. The transport robot according to claim 4, further comprising:
a sensor unit configured to detect at least one surrounding obstacle,
wherein
the controller is configured to calculate position information of the obstacle based on information about a peripheral area recognized by the sensor unit.

7. The transport robot according to claim 6, wherein the controller is configured to:
calculate a driving path to a destination based on fixed map information about the destination; and
calculate a modified path and a driving speed for enabling the transport robot to move while avoiding the obstacle based on the position information of the trailer and the position information of the obstacle.

8. The transport robot according to claim 7, wherein the controller is configured to:
calculate an expected position of the trailer based on wheel position information of the trailer, weight information of the trailer, and weight information of articles loaded on the trailer; and
calculate the modified path and the driving speed to prevent the transport robot from colliding with the obstacle at the expected position of the trailer.

9. The transport robot according to claim 7, wherein the controller is configured to:
measure a distance to the trailer based on position information of the obstacle and position information of the trailer; and
set the driving speed to zero “0” when the trailer is located within a predetermined distance from the obstacle.

10. The transport robot according to claim 9, wherein the controller is configured to:
rotate the body such that a direction of the encoder is at an angle of 180 degrees with respect to the driving direction; and
calculate a modified path so that the transport robot drives in a straight direction until the obstacle and the trailer are spaced apart from each other by a predetermined distance or more.

11. A transport means comprising:
a transport robot including a body provided with a driving unit and a connector holder coupled to the body; and
a trailer including a connector rotatably coupled to the connector holder of the transport robot,
wherein the connector holder includes:
a fixed bracket fixed to the body;
a rotation bracket rotatably coupled to the fixed bracket; and
a fastening pin configured to penetrate the connector of the trailer and fastened to the rotation bracket.

12. The transport means according to claim 11, wherein the connector includes:
a connection bracket rotatably coupled to a frame of the trailer in a vertical direction; and
a rod-end bearing located at an end of the connection bracket and configured to enable the fastening pin to pass therethrough.

13. The transport means according to claim 12, further comprising:
an auxiliary roller rotatably coupled to a lower part of the connection bracket with respect to a rotary shaft arranged horizontal to an extension direction of the connection bracket.

14. The transport means according to claim 11, wherein the transport robot further includes:
an encoder configured to detect rotation of the rotation bracket; and
a controller configured to calculate position information of the trailer based on rotation amount data of the rotation bracket measured by the encoder.

15. The transport means according to claim 14, wherein the transport robot further includes:
a sensor unit configured to detect at least one surrounding obstacle,
wherein the controller is configured to:
calculate position information of an obstacle based on information about a peripheral area recognized by the sensor unit;
calculate a driving path to a destination based on fixed map information about the destination; and
calculate a modified path and a driving speed for enabling the transport robot to move while avoiding the obstacle based on the position information of the trailer and the position information of the obstacle.

16. A method for controlling a transport robot comprising:
receiving a command required to move the transport robot to a destination;
calculating a driving path to the destination;
calculating a driving speed;
controlling a driving unit so that the transport robot drives along the driving path at the driving speed;
calculating position information of a connected trailer;
recognizing obstacles present in a peripheral area; and
calculating a modified path so that the trailer does not collide with the obstacle based on the position information of the trailer.

17. The method according to claim 16, wherein:
measuring a distance to the trailer based on position information of the obstacle and position information of the trailer; and
setting the driving speed to zero “0” when the trailer is located within a predetermined distance from the obstacle.

18. The method according to claim 16, further comprising:
rotating the transport robot such that a direction of connection between the trailer and the transport robot is at an angle of 180 degrees with respect to a driving direction; and
calculating a modified path so that the transport robot drives in a straight direction until the obstacle and the trailer are spaced apart from each other by a predetermined distance or more.

19. The method according to claim 16, wherein the calculating the position information of the trailer includes:
receiving information about an angle between the trailer and the transport robot; and
calculating an expected position of the trailer based on the angle, wheel position information of the trailer, weight information of the trailer, and weight information of articles loaded on the trailer.

20. The method according to claim 19, further comprising:
calculating the modified path and the driving speed to prevent the transport robot from colliding with the obstacle at the expected position of the trailer.
